(19) United States
(12) Patent Application Publication
(10) Pub. No.: US 2025/0071318 A1
(43) Pub. Date: Feb. 27, 2025

(54) IMAGE ENCODING/DECODING METHOD AND DEVICE, AND RECORDING MEDIUM STORING BITSTREAM

(71) Applicant: LG Electronics Inc., Seoul (KR)

(72) Inventors: Hyeongmoon JANG, Seoul (KR); Naeri PARK, Seoul (KR); Junghak NAM, Seoul (KR)

(21) Appl. No.: 18/726,205

(22) PCT Filed: Jan. 4, 2023
(86) PCT No.: PCT/KR2023/000165

§ 371 Date: Jul. 2, 2024

(30) Foreign Application Priority Data
Jan. 4, 2022 (KR) 10-2022-0000777

(51) Int. Cl. H04N 19/52; H04N 19/139; H04N 19/176; H04N 19/184

(52) U.S. Cl. CPC H04N 19/52; H04N 19/139; H04N 19/176; H04N 19/184

(57) ABSTRACT

An image decoding/encoding method and device according to the present disclosure may configure a merge candidate list of a current block, derive motion information of the current block on the basis of the merge candidate list and a merge index, and perform inter prediction for the current block on the basis of the motion information of the current block. Here, the merge candidate list may include a candidate derived using an affine motion model of an affine block coded by affine prediction.

### CROSS-REFERENCE TO RELATED APPLICATIONS

This application is the National Stage filing under 35 U.S.C. 371 of International Application No. PCT/KR2023/000165, filed on Jan. 4, 2023, which claims the benefit of earlier filing date and right of priority to Korean Application No. 10-2022-0000777, filed on Jan. 4, 2022, the contents of which are all incorporated by reference herein in their entireties.

### TECHNICAL FIELD

The present disclosure relates to an image encoding/decoding method and device, and a recording medium storing a bitstream.

### BACKGROUND

Recently, the demand for high-resolution and high-quality images such as HD (High Definition) images and UHD (Ultra High Definition) images has been increasing in various application fields, and accordingly, highly efficient image compression technologies are being discussed.

There are a variety of technologies such as inter-prediction technology that predicts a pixel value included in a current picture from a picture before or after a current picture with video compression technology, intra-prediction technology that predicts a pixel value included in a current picture by using pixel information in a current picture, entropy coding technology that allocates a short sign to a value with high appearance frequency and a long sign to a value with low appearance frequency, etc. and these image compression technologies may be used to effectively compress image data and transmit or store it.

### SUMMARY

The present disclosure seeks to provide a method and

a device for using an affine model of an affine block in a non-affine mode.

The present disclosure seeks to provide a method and a device for deriving a candidate by using an affine model of an affine block in a non-affine mode.

The present disclosure seeks to provide a method and a device for configuring a candidate list by using a candidate derived by using an affine model of an affine block in a non-affine mode.

An image decoding method and device according to the present disclosure may configure a merge candidate list of a current block, derive motion information of the current block based on the merge candidate list and a merge index, and perform inter prediction for the current block based on motion information of the current block.

In an image decoding method and device according to the present disclosure, the merge candidate list may include a candidate derived by using an affine motion model of an affine block coded by affine prediction.

In an image decoding method and device according to the present disclosure, the merge index may indicate one of a plurality of candidates included in the merge candidate list.

In an image decoding method and device according to the present disclosure, the motion information of a candidate derived by using an affine motion model of the affine block may be motion information derived for a predefined position in a current block from the affine motion model.

In an image decoding method and device according to the present disclosure, the predefined position may be defined as one of top-left, bottom-left, top-right, bottom-right or center positions of the current block.

In an image decoding method and device according to the present disclosure, the affine block may be determined to be a block coded by affine prediction among blocks at a predefined position based on the current block.

In an image decoding method and device according to the present disclosure, whether it is a block coded by affine prediction according to a predetermined priority among blocks at the predefined position may be confirmed.

In an image decoding method and device according to the present disclosure, the affine block may be determined as a block coded by affine prediction among spatial merge candidates of the current block.

In an image decoding method and device according to the present disclosure, the affine block may be determined as a block coded by affine prediction among non-adjacent spatial merge candidates that are not adjacent to the current block.

In an image decoding method and device according to the present disclosure, a position of a non-adjacent spatial merge candidate that is not adjacent to the current block may be adaptively determined based on a width and a height of the current block.

In an image decoding method and device according to the present disclosure, a position of a non-adjacent spatial merge candidate that is not adjacent to the current block may be defined as a specific position in a grid with a predefined size.

In an image decoding method and device according to the present disclosure, at least one of a spatial merge candidate having a motion vector of a block spatially adjacent to the current block, a temporal merge candidate having a motion vector of a block temporally adjacent to the current block, a non-adjacent spatial merge candidate having a motion vector of a block spatially non-adjacent to the current block or a candidate derived by using an affine motion model of an affine block may be included.

An image decoding method and device according to the present disclosure may perform inter prediction by generating a prediction block of the current block from one reference block specified by motion information of the current block.

An image encoding method and device according to the present disclosure may configure a merge candidate list of a current block, determine motion information of the current block based on the merge candidate list and perform inter prediction for the current block based on motion information of the current block.

In an image encoding method and device according to the present disclosure, the merge candidate list may include a candidate derived by using an affine motion model of an affine block coded by affine prediction.

In an image encoding method and device according to the present disclosure, the merge index may indicate one of a plurality of candidates included in the merge candidate list.

In an image encoding method and device according to the present disclosure, the motion information of a candidate derived by using an affine motion model of the affine block may be motion information derived for a predefined position in a current block from the affine motion model.

In an image encoding method and device according to the present disclosure, the predefined position may be defined as one of top-left, bottom-left, top-right, bottom-right or center positions of the current block.

In an image encoding method and device according to the present disclosure, the affine block may be determined to be a block coded by affine prediction among blocks at a predefined position based on the current block.

In an image encoding method and device according to the present disclosure, whether it is a block coded by affine prediction according to a predetermined priority among blocks at the predefined position may be confirmed.

In an image encoding method and device according to the present disclosure, the affine block may be determined as a block coded by affine prediction among spatial merge candidates of the current block.

In an image encoding method and device according to the present disclosure, the affine block may be determined as a block coded by affine prediction among non-adjacent spatial merge candidates that are not adjacent to the current block.

In an image encoding method and device according to the present disclosure, a position of a non-adjacent spatial merge candidate that is not adjacent to the current block may be adaptively determined based on a width and a height of the current block.

In an image encoding method and device according to the present disclosure, a position of a non-adjacent spatial merge candidate that is not adjacent to the current block may be defined as a specific position in a grid with a predefined size.

In an image encoding method and device according to the present disclosure, the merge candidate list may include a plurality of merge candidates, and the plurality of merge candidates may include at least one of a spatial merge candidate having a motion vector of a block spatially adjacent to the current block, a temporal merge candidate having a motion vector of a block temporally adjacent to the current block, a non-adjacent spatial merge candidate having a motion vector of a block spatially non-adjacent to the current block or a candidate derived by using an affine motion model of an affine block.

An image encoding method and device according to the present disclosure may perform inter prediction by generating a prediction block of the current block from one reference block specified by motion information of the current block.

A computer-readable digital storage medium storing encoded video/image information resulting in performing an image decoding method due to a decoding device according to the present disclosure is provided.

A computer-readable digital storage medium storing video/image information generated according to an image encoding method according to the present disclosure is provided.

A method and a device for transmitting video/image information generated according to an image encoding method according to the present disclosure are provided.

According to the present disclosure, the accuracy and reliability of inter prediction may be improved by generating various candidates by deriving a candidate by using an affine model of an affine block in a non-affine mode.

According to the present disclosure, the encoding efficiency of a candidate index may be improved by configuring a merge candidate list by effectively considering a candidate using an affine model of an affine block.

According to the present disclosure, in addition to the existing motion information simply stored in a predefined position, motion information derived based on an affine motion model may be additionally considered for prediction to consider various movements as a candidate, increasing the accuracy of prediction and improving compression performance.

### BRIEF DESCRIPTION OF THE DRAWINGS

FIG. 1 shows a video/image coding system according to the present disclosure.

FIG. 2 shows a rough block diagram of an encoding device to which an embodiment of the present disclosure may be applied and encoding of a video/image signal is performed.

FIG. 3 shows a rough block diagram of a decoding device to which an embodiment of the present disclosure may be applied and decoding of a video/image signal is performed.

FIG. 4 shows an inter prediction method based on a merge mode performed by a decoding device as an embodiment to which the present disclosure is applied.

FIGS. 5 and 6 show a neighboring block that may be used as a spatial merge candidate as an embodiment to which the present disclosure is applied.

FIGS. 7 to 10 are a diagram for describing a non-affine merge mode using motion information of an affine block according to an embodiment of the present disclosure.

FIG. 11 is a diagram illustrating a position of a neighboring block for candidate configuration according to an embodiment of the present disclosure.

FIG. 12 is a diagram illustrating a position of a neighboring block for candidate configuration according to an embodiment of the present disclosure.

FIG. 13 is a diagram illustrating a position of a neighboring block for candidate configuration according to an embodiment of the present disclosure.

FIG. 14 is a flowchart illustrating a method for configuring a merge candidate list according to an embodiment of the present disclosure.

FIG. 15 is a flowchart illustrating a method for configuring a merge candidate list according to an embodiment of the present disclosure.

FIG. 16 is a flowchart illustrating a method for configuring a merge candidate list according to an embodiment of the present disclosure.

FIG. 17 is a flowchart illustrating a method for configuring a merge candidate list according to an embodiment of the present disclosure.

FIG. 18 shows a rough configuration of an inter prediction unit 332 that performs merge mode-based inter prediction as an embodiment according to the present disclosure.

FIG. 19 shows an inter prediction method based on a merge mode performed by an encoding device as an embodiment according to the present disclosure.

FIG. 20 shows a rough configuration of an inter prediction unit 221 that performs merge mode-based inter prediction as an embodiment according to the present disclosure.

FIG. 21 shows an example of a contents streaming system to which embodiments of the present disclosure may be applied.

### DETAILED DESCRIPTION

Since the present disclosure may make various changes and have several embodiments, specific embodiments will be illustrated in a drawing and described in detail in a detailed description. However, it is not intended to limit the present disclosure to a specific embodiment, and should be understood to include all changes, equivalents and substitutes included in the spirit and technical scope of the present disclosure. While describing each drawing, similar reference numerals are used for similar components.

A term such as first, second, etc. may be used to describe various components, but the components should not be limited by the terms. The terms are used only to distinguish one component from other components. For example, a first component may be referred to as a second component without departing from the scope of a right of the present disclosure, and similarly, a second component may also be referred to as a first component. A term of and/or includes any of a plurality of related stated items or a combination of a plurality of related stated items.

When a component is referred to as “being connected” or “being linked” to another component, it should be understood that it may be directly connected or linked to another component, but another component may exist in the middle. On the other hand, when a component is referred to as “being directly connected” or “being directly linked” to another component, it should be understood that there is no another component in the middle.

A term used in this application is just used to describe a specific embodiment, and is not intended to limit the present disclosure. Singular expressions include plural expressions unless the context clearly dictates otherwise. In this application, it should be understood that a term such as “include” or “have”, etc. is intended to designate the presence of features, numbers, steps, operations, components, parts or combinations thereof described in the specification, but does not exclude in advance the possibility of presence or addition of one or more other features, numbers, steps, operations, components, parts or combinations thereof.

The present disclosure relates to video/image coding. For example, a method/an embodiment disclosed herein may be applied to a method disclosed in the versatile video coding (VVC) standard. In addition, a method/an embodiment disclosed herein may be applied to a method disclosed in the essential video coding (EVC) standard, the AOMedia Video 1 (AV1) standard, the 2nd generation of audio video coding standard (AVS2) or the next-generation video/image coding standard (ex. H.267 or H.268, etc.).

This specification proposes various embodiments of video/image coding, and unless otherwise specified, the embodiments may be performed in combination with each other.

Herein, a video may refer to a set of a series of images over time. A picture generally refers to a unit representing one image in a specific time period, and a slice/a tile is a unit that forms part of a picture in coding. A slice/a tile may include at least one coding tree unit (CTU). One picture may consist of at least one slice/tile. One tile is a rectangular area composed of a plurality of CTUs within a specific tile column and a specific tile row of one picture. A tile column is a rectangular area of CTUs having the same height as that of a picture and a width designated by a syntax requirement of a picture parameter set. A tile row is a rectangular area of CTUS having a height designated by a picture parameter set and the same width as that of a picture. CTUs within one tile may be arranged consecutively according to CTU raster scan, while tiles within one picture may be arranged consecutively according to raster scan of a tile. One slice may include an integer number of complete tiles or an integer number of consecutive complete CTU rows within a tile of a picture that may be included exclusively in a single NAL unit. Meanwhile, one picture may be divided into at least two sub-pictures. A sub-picture may be a rectangular area of at least one slice within a picture.

A pixel, a pixel or a pel may refer to the minimum unit that constitutes one picture (or image). In addition, ‘sample’ may be used as a term corresponding to a pixel. A sample may generally represent a pixel or a pixel value, and may represent only a pixel/a pixel value of a luma component, or only a pixel/a pixel value of a chroma component.

A unit may represent a basic unit of image processing. A unit may include at least one of a specific area of a picture and information related to a corresponding area. One unit may include one luma block and two chroma (ex. cb, cr) blocks. In some cases, a unit may be used interchangeably with a term such as a block or an area, etc. In a general case, a M×N block may include a set (or an array) of transform coefficients or samples (or sample arrays) consisting of M columns and N rows.

Herein, “A or B” may refer to “only A”, “only B” or “both A and B.” In other words, herein, “A or B” may be interpreted as “A and/or B.” For example, herein, “A, B or C” may refer to “only A”, “only B”, “only C” or “any combination of A, B and C)”.

A slash (/) or a comma used herein may refer to “and/or.” For example, “A/B” may refer to “A and/or B.” Accordingly, “A/B” may refer to “only A”, “only B” or “both A and B.” For example, “A, B, C” may refer to “A, B, or C”.

Herein, “at least one of A and B” may refer to “only A”, “only B” or “both A and B”. In addition, herein, an expression such as “at least one of A or B” or “at least one of A and/or B” may be interpreted in the same way as “at least one of A and B”.

In addition, herein, “at least one of A, B and C” may refer to “only A”, “only B”, “only C”, or “any combination of A, B and C”. In addition, “at least one of A, B or C” or “at least one of A, B and/or C” may refer to “at least one of A, B and C”.

In addition, a parenthesis used herein may refer to “for example.” Specifically, when indicated as “prediction (intra prediction)”, “intra prediction” may be proposed as an example of “prediction”. In other words, “prediction” herein is not limited to “intra prediction” and “intra prediction” may be proposed as an example of “prediction.” In addition, even when indicated as “prediction (i.e., intra prediction)”, “intra prediction” may be proposed as an example of “prediction.”

Herein, a technical feature described individually in one drawing may be implemented individually or simultaneously.

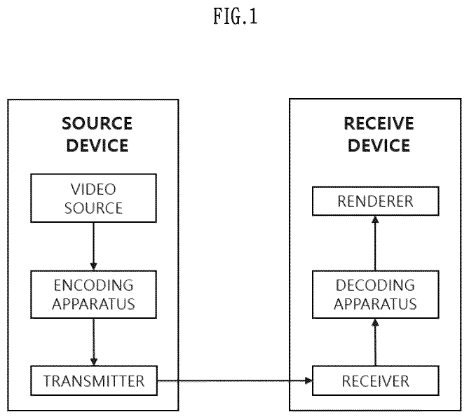

FIG. 1 shows a video/image coding system according to the present disclosure.

Referring to FIG. 1, a video/image coding system may include a first device (a source device) and a second device (a receiving device).

A source device may transmit encoded video/image information or data in a form of a file or streaming to a receiving device through a digital storage medium or a network. The source device may include a video source, an encoding device and a transmission unit. The receiving device may include a reception unit, a decoding device and a renderer. The encoding device may be referred to as a video/image encoding device and the decoding device may be referred to as a video/image decoding device. A transmitter may be included in an encoding device. A receiver may be included in a decoding device. A renderer may include a display unit, and a display unit may be composed of a separate device or an external component.

A video source may acquire a video/an image through a process of capturing, synthesizing or generating a video/an image. A video source may include a device of capturing a video/an image and a device of generating a video/an image. A device of capturing a video/an image may include at least one camera, a video/image archive including previously captured videos/images, etc. A device of generating a video/an image may include a computer, a tablet, a smartphone, etc. and may (electronically) generate a video/an image. For example, a virtual video/image may be generated through a computer, etc., and in this case, a process of capturing a video/an image may be replaced by a process of generating related data.

An encoding device may encode an input video/image. An encoding device may perform a series of procedures such as prediction, transform, quantization, etc. for compression and coding efficiency. Encoded data (encoded video/image information) may be output in a form of a bitstream.

A transmission unit may transmit encoded video/image information or data output in a form of a bitstream to a reception unit of a receiving device through a digital storage medium or a network in a form of a file or streaming. A digital storage medium may include various storage media such as USB, SD, CD, DVD, Blu-ray, HDD, SSD, etc. A transmission unit may include an element for generating a media file through a predetermined file format and may include an element for transmission through a broadcasting/communication network. A reception unit may receive/extract the bitstream and transmit it to a decoding device.

A decoding device may decode a video/an image by performing a series of procedures such as dequantization, inverse transform, prediction, etc. corresponding to an operation of an encoding device.

A renderer may render a decoded video/image. A rendered video/image may be displayed through a display unit.

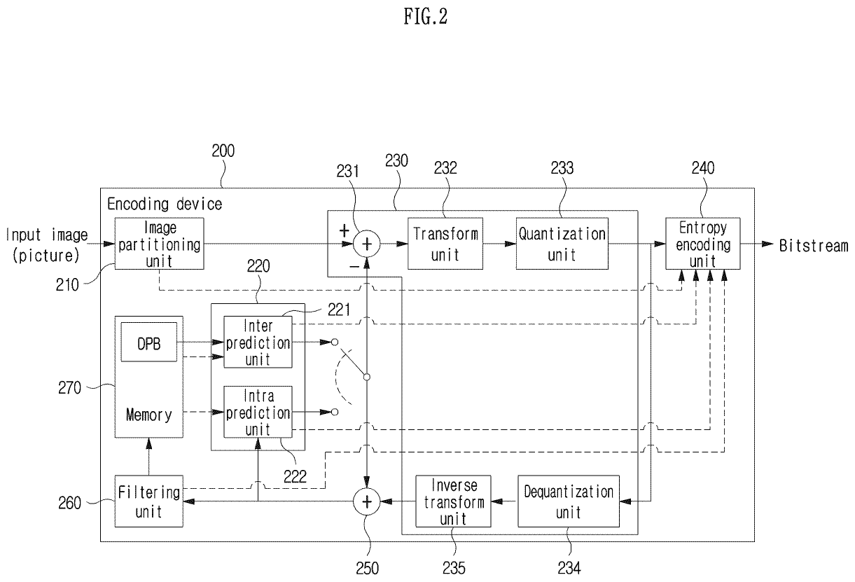

FIG. 2 shows a rough block diagram of an encoding device to which an embodiment of the present disclosure may be applied and encoding of a video/image signal is performed.

Referring to FIG. 2, an encoding device 200 may be composed of an image partitioner 210, a predictor 220, a residual processor 230, an entropy encoder 240, an adder 250, a filter 260 and a memory 270. A predictor 220 may include an inter predictor 221 and an intra predictor 222. A residual processor 230 may include a transformer 232, a quantizer 233, a dequantizer 234 and an inverse transformer 235. A residual processor 230 may further include a subtractor 231. An adder 250 may be referred to as a reconstructor or a reconstructed block generator. The above-described image partitioner 210, predictor 220, residual processor 230, entropy encoder 240, adder 250 and filter 260 may be configured by at least one hardware component (e.g., an encoder chipset or a processor) according to an embodiment. In addition, a memory 270 may include a decoded picture buffer (DPB) and may be configured by a digital storage medium. The hardware component may further include a memory 270 as an internal/external component.

An image partitioner 210 may partition an input image (or picture, frame) input to an encoding device 200 into at least one processing unit. As an example, the processing unit may be referred to as a coding unit (CU). In this case, a coding unit may be partitioned recursively according to a quad-tree binary-tree ternary-tree (QTBTTT) structure from a coding tree unit (CTU) or the largest coding unit (LCU).

For example, one coding unit may be partitioned into a plurality of coding units with a deeper depth based on a quad tree structure, a binary tree structure and/or a ternary structure. In this case, for example, a quad tree structure may be applied first and a binary tree structure and/or a ternary structure may be applied later. Alternatively, a binary tree structure may be applied before a quad tree structure. A coding procedure according to this specification may be performed based on a final coding unit that is no longer partitioned. In this case, based on coding efficiency, etc. according to an image characteristic, the largest coding unit may be directly used as a final coding unit, or if necessary, a coding unit may be recursively partitioned into coding units of a deeper depth, and a coding unit with an optimal size may be used as a final coding unit. Here, a coding procedure may include a procedure such as prediction, transform, and reconstruction, etc. described later.

As another example, the processing unit may further include a prediction unit (PU) or a transform unit (TU). In this case, the prediction unit and the transform unit may be divided or partitioned from a final coding unit described above, respectively. The prediction unit may be a unit of sample prediction, and the transform unit may be a unit for deriving a transform coefficient and/or a unit for deriving a residual signal from a transform coefficient.

In some cases, a unit may be used interchangeably with a term such as a block or an area, etc. In a general case, a M×N block may represent a set of transform coefficients or samples consisting of M columns and N rows. A sample may generally represent a pixel or a pixel value, and may represent only a pixel/a pixel value of a luma component, or only a pixel/a pixel value of a chroma component. A sample may be used as a term that makes one picture (or image) correspond to a pixel or a pel.

An encoding device 200 may subtract a prediction signal (a prediction block, a prediction sample array) output from an inter predictor 221 or an intra predictor 222 from an input image signal (an original block, an original sample array) to generate a residual signal (a residual signal, a residual sample array), and a generated residual signal is transmitted to a transformer 232. In this case, a unit that subtracts a prediction signal (a prediction block, a prediction sample array) from an input image signal (an original block, an original sample array) within an encoding device 200 may be referred to as a subtractor 231.

A predictor 220 may perform prediction on a block to be processed (hereinafter, referred to as a current block) and generate a predicted block including prediction samples for the current block. A predictor 220 may determine whether intra prediction or inter prediction is applied in a unit of a current block or a CU. A predictor 220 may generate various information on prediction such as prediction mode information, etc. and transmit it to an entropy encoder 240 as described later in a description of each prediction mode. Information on prediction may be encoded in an entropy encoder 240 and output in a form of a bitstream.

An intra predictor 222 may predict a current block by referring to samples within a current picture. The samples referred to may be positioned in the neighborhood of the current block or may be positioned a certain distance away from the current block according to a prediction mode. In intra prediction, prediction modes may include at least one nondirectional mode and a plurality of directional modes. A nondirectional mode may include at least one of a DC mode or a planar mode. A directional mode may include 33 directional modes or 65 directional modes according to a detail level of a prediction direction. However, it is an example, and more or less directional modes may be used according to a configuration. An intra predictor 222 may determine a prediction mode applied to a current block by using a prediction mode applied to a neighboring block.

An inter predictor 221 may derive a prediction block for a current block based on a reference block (a reference sample array) specified by a motion vector on a reference picture. In this case, in order to reduce the amount of motion information transmitted in an inter prediction mode, motion information may be predicted in a unit of a block, a sub-block or a sample based on the correlation of motion information between a neighboring block and a current block. The motion information may include a motion vector and a reference picture index. The motion information may further include inter prediction direction information (L0 prediction, L1 prediction, Bi prediction, etc.). For inter prediction, a neighboring block may include a spatial neighboring block existing in a current picture and a temporal neighboring block existing in a reference picture. A reference picture including the reference block and a reference picture including the temporal neighboring block may be the same or different. The temporal neighboring block may be referred to as a collocated reference block, a collocated CU (colCU), etc., and a reference picture including the temporal neighboring block may be referred to as a collocated picture (colPic). For example, an inter predictor 221 may configure a motion information candidate list based on neighboring blocks and generate information indicating which candidate is used to derive a motion vector and/or a reference picture index of the current block. Inter prediction may be performed based on various prediction modes, and for example, for a skip mode and a merge mode, an inter predictor 221 may use motion information of a neighboring block as motion information of a current block. For a skip mode, unlike a merge mode, a residual signal may not be transmitted. For a motion vector prediction (MVP) mode, a motion vector of a surrounding block is used as a motion vector predictor and a motion vector difference is signaled to indicate a motion vector of a current block.

A predictor 220 may generate a prediction signal based on various prediction methods described later. For example, a predictor may not only apply intra prediction or inter prediction for prediction for one block, but also may apply intra prediction and inter prediction simultaneously. It may be referred to as a combined inter and intra prediction (CIIP) mode. In addition, a predictor may be based on an intra block copy (IBC) prediction mode or may be based on a palette mode for prediction for a block. The IBC prediction mode or palette mode may be used for content image/video coding of a game, etc. such as screen content coding (SCC), etc. IBC basically performs prediction within a current picture, but it may be performed similarly to inter prediction in that it derives a reference block within a current picture. In other words, IBC may use at least one of inter prediction techniques described herein. A palette mode may be considered as an example of intra coding or intra prediction. When a palette mode is applied, a sample value within a picture may be signaled based on information on a palette table and a palette index. A prediction signal generated through the predictor 220 may be used to generate a reconstructed signal or a residual signal.

A transformer 232 may generate transform coefficients by applying a transform technique to a residual signal. For example, a transform technique may include at least one of Discrete Cosine Transform (DCT), Discrete Sine Transform (DST), Karhunen-Loeve Transform (KLT), Graph-Based Transform (GBT) or Conditionally Non-linear Transform (CNT). Here, GBT refers to transform obtained from this graph when relationship information between pixels is expressed as a graph. CNT refers to transform obtained based on generating a prediction signal by using all previously reconstructed pixels. In addition, a transform process may be applied to a square pixel block in the same size or may be applied to a non-square block in a variable size.

A quantizer 233 may quantize transform coefficients and transmit them to an entropy encoder 240 and an entropy encoder 240 may encode a quantized signal (information on quantized transform coefficients) and output it as a bitstream. Information on the quantized transform coefficients may be referred to as residual information. A quantizer 233 may rearrange quantized transform coefficients in a block form into an one-dimensional vector form based on coefficient scan order, and may generate information on the quantized transform coefficients based on the quantized transform coefficients in the one-dimensional vector form.

An entropy encoder 240 may perform various encoding methods such as exponential Golomb, context-adaptive variable length coding (CAVLC), context-adaptive binary arithmetic coding (CABAC), etc. An entropy encoder 240 may encode information necessary for video/image reconstruction (e.g., a value of syntax elements, etc.) other than quantized transform coefficients together or separately.

Encoded information (ex. encoded video/image information) may be transmitted or stored in a unit of a network abstraction layer (NAL) unit in a bitstream form. The video/image information may further include information on various parameter sets such as an adaptation parameter set (APS), a picture parameter set (PPS), a sequence parameter set (SPS) or a video parameter set (VPS), etc. In addition, the video/image information may further include general constraint information. Herein, information and/or syntax elements transmitted/signaled from an encoding device to a decoding device may be included in video/image information. The video/image information may be encoded through the above-described encoding procedure and included in the bitstream. The bitstream may be transmitted through a network or may be stored in a digital storage medium. Here, a network may include a broadcasting network and/or a communication network, etc. and a digital storage medium may include various storage media such as USB, SD, CD, DVD, Blu-ray, HDD, SSD, etc. A transmission unit (not shown) for transmitting and/or a storage unit (not shown) for storing a signal output from an entropy encoder 240 may be configured as an internal/external element of an encoding device 200, or a transmission unit may be also included in an entropy encoder 240.

Quantized transform coefficients output from a quantizer 233 may be used to generate a prediction signal. For example, a residual signal (a residual block or residual samples) may be reconstructed by applying dequantization and inverse transform to quantized transform coefficients through a dequantizer 234 and an inverse transformer 235. An adder 250 may add a reconstructed residual signal to a prediction signal output from an inter predictor 221 or an intra predictor 222 to generate a reconstructed signal (a reconstructed picture, a reconstructed block, a reconstructed sample array). When there is no residual for a block to be processed like when a skip mode is applied, a predicted block may be used as a reconstructed block. An adder 250 may be referred to as a reconstructor or a reconstructed block generator. A generated reconstructed signal may be used for intra prediction of a next block to be processed within a current picture, and may be also used for inter prediction of a next picture through filtering as described later. Meanwhile, luma mapping with chroma scaling (LMCS) may be applied in a picture encoding and/or reconstruction process.

A filter 260 may improve subjective/objective image quality by applying filtering to a reconstructed signal. For example, a filter 260 may generate a modified reconstructed picture by applying various filtering methods to a reconstructed picture, and may store the modified reconstructed picture in a memory 270, specifically in a DPB of a memory 270. The various filtering methods may include deblocking filtering, sample adaptive offset, adaptive loop filter, bilateral filter, etc. A filter 260 may generate various information on filtering and transmit it to an entropy encoder 240. Information on filtering may be encoded in an entropy encoder 240 and output in a form of a bitstream.

A modified reconstructed picture transmitted to a memory 270 may be used as a reference picture in an inter predictpr 221. When inter prediction is applied through it, an encoding device may avoid prediction mismatch in an encoding device 200 and a decoding device, and may also improve encoding efficiency.

A DPB of a memory 270 may store a modified reconstructed picture to use it as a reference picture in an inter predictor 221. A memory 270 may store motion information of a block from which motion information in a current picture is derived (or encoded) and/or motion information of blocks in a pre-reconstructed picture. The stored motion information may be transmitted to an inter predictor 221 to be used as motion information of a spatial neighboring block or motion information of a temporal neighboring block. A memory 270 may store reconstructed samples of reconstructed blocks in a current picture and transmit them to an intra predictor 222.

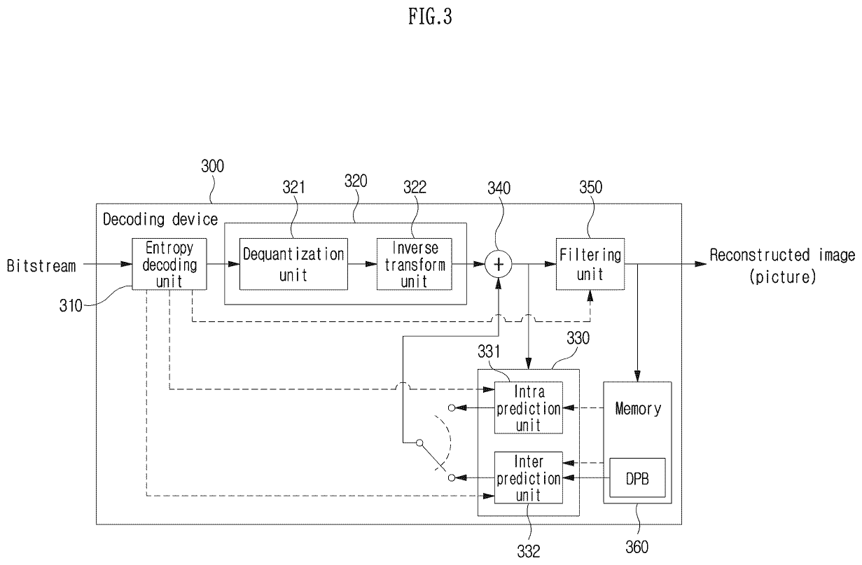

FIG. 3 shows a rough block diagram of a decoding device to which an embodiment of the present disclosure may be applied and decoding of a video/image signal is performed.

Referring to FIG. 3, a decoding device 300 may be configured by including an entropy decoder 310, a residual processor 320, a predictor 330, an adder 340, a filter 350 and a memory 360. A predictor 330 may include an inter predictor 331 and an intra predictor 332. A residual processor 320 may include a dequantizer 321 and an inverse transformer 321.

According to an embodiment, the above-described entropy decoder 310, residual processor 320, predictor 330, adder 340 and filter 350 may be configured by one hardware component (e.g., a decoder chipset or a processor). In addition, a memory 360 may include a decoded picture buffer (DPB) and may be configured by a digital storage medium. The hardware component may further include a memory 360 as an internal/external component.

When a bitstream including video/image information is input, a decoding device 300 may reconstruct an image in response to a process in which video/image information is processed in an encoding device of FIG. 2. For example, a decoding device 300 may derive units/blocks based on block partition-related information obtained from the bitstream. A decoding device 300 may perform decoding by using a processing unit applied in an encoding device. Accordingly, a processing unit of decoding may be a coding unit, and a coding unit may be partitioned from a coding tree unit or the largest coding unit according to a quad tree structure, a binary tree structure and/or a ternary tree structure. At least one transform unit may be derived from a coding unit. And, a reconstructed image signal decoded and output through a decoding device 300 may be played through a playback device.

A decoding device 300 may receive a signal output from an encoding device of FIG. 2 in a form of a bitstream, and a received signal may be decoded through an entropy decoder 310. For example, an entropy decoder 310 may parse the bitstream to derive information (ex. video/image information) necessary for image reconstruction (or picture reconstruction). The video/image information may further include information on various parameter sets such as an adaptation parameter set (APS), a picture parameter set (PPS), a sequence parameter set (SPS) or a video parameter set (VPS), etc. In addition, the video/image information may further include general constraint information. A decoding device may decode a picture further based on information on the parameter set and/or the general constraint information. Signaled/received information and/or syntax elements described later herein may be decoded through the decoding procedure and obtained from the bitstream. For example, an entropy decoder 310 may decode information in a bitstream based on a coding method such as exponential Golomb encoding, CAVLC, CABAC, etc. and output a value of a syntax element necessary for image reconstruction and quantized values of a transform coefficient regarding a residual. In more detail, a CABAC entropy decoding method may receive a bin corresponding to each syntax element from a bitstream, determine a context model by using syntax element information to be decoded, decoding information of a surrounding block and a block to be decoded or information of a symbol/a bin decoded in a previous step, perform arithmetic decoding of a bin by predicting a probability of occurrence of a bin according to a determined context model and generate a symbol corresponding to a value of each syntax element. In this case, a CABAC entropy decoding method may update a context model by using information on a decoded symbol/bin for a context model of a next symbol/bin after determining a context model. Among information decoded in an entropy decoder 310, information on prediction is provided to a predictor (an inter predictor 332 and an intra predictor 331), and a residual value on which entropy decoding was performed in an entropy decoder 310, i.e., quantized transform coefficients and related parameter information may be input to a residual processor 320. A residual processor 320 may derive a residual signal (a residual block, residual samples, a residual sample array). In addition, information on filtering among information decoded in an entropy decoder 310 may be provided to a filter 350. Meanwhile, a reception unit (not shown) that receives a signal output from an encoding device may be further configured as an internal/external element of a decoding device 300 or a reception unit may be a component of an entropy decoder 310.

Meanwhile, a decoding device according to this specification may be referred to as a video/image/picture decoding device, and the decoding device may be divided into an information decoder (a video/image/picture information decoder) and a sample decoder (a video/image/picture sample decoder). The information decoder may include the entropy decoder 310 and the sample decoder may include at least one of dequantizer 321, the inverse transformer 322, the adder 340, the filter 350, the memory 360, the inter predictor 332 and the intra predictor 331.

A dequantizer 321 may dequantize quantized transform coefficients and output transform coefficients. A dequantizer 321 may rearrange quantized transform coefficients into a two-dimensional block form. In this case, the rearrangement may be performed based on coefficient scan order performed in an encoding device. A dequantizer 321 may perform dequantization on quantized transform coefficients by using a quantization parameter (e.g., quantization step size information) and obtain transform coefficients.

An inverse transformer 322 inversely transforms transform coefficients to obtain a residual signal (a residual block, a residual sample array).

A predictor 320 may perform prediction on a current block and generate a predicted block including prediction samples for the current block. A predictor 320 may determine whether intra prediction or inter prediction is applied to the current block based on the information on prediction output from an entropy decoder 310 and determine a specific intra/inter prediction mode.

A predictor 320 may generate a prediction signal based on various prediction methods described later. For example, a predictor 320 may not only apply intra prediction or inter prediction for prediction for one block, but also may apply intra prediction and inter prediction simultaneously. It may be referred to as a combined inter and intra prediction (CIIP) mode. In addition, a predictor may be based on an intra block copy (IBC) prediction mode or may be based on a palette mode for prediction for a block. The IBC prediction mode or palette mode may be used for content image/video coding of a game, etc. such as screen content coding (SCC), etc. IBC basically performs prediction within a current picture, but it may be performed similarly to inter prediction in that it derives a reference block within a current picture. In other words, IBC may use at least one of inter prediction techniques described herein. A palette mode may be considered as an example of intra coding or intra prediction. When a palette mode is applied, information on a palette table and a palette index may be included in the video/image information and signaled.

An intra predictor 331 may predict a current block by referring to samples within a current picture. The samples referred to may be positioned in the neighborhood of the current block or may be positioned a certain distance away from the current block according to a prediction mode. In intra prediction, prediction modes may include at least one nondirectional mode and a plurality of directional modes. An intra predictor 331 may determine a prediction mode applied to a current block by using a prediction mode applied to a neighboring block.

An inter predictor 332 may derive a prediction block for a current block based on a reference block (a reference sample array) specified by a motion vector on a reference picture. In this case, in order to reduce the amount of motion information transmitted in an inter prediction mode, motion information may be predicted in a unit of a block, a sub-block or a sample based on the correlation of motion information between a neighboring block and a current block. The motion information may include a motion vector and a reference picture index. The motion information may further include inter prediction direction information (L0 prediction, L1 prediction, Bi prediction, etc.). For inter prediction, a neighboring block may include a spatial neighboring block existing in a current picture and a temporal neighboring block existing in a reference picture. For example, an inter predictor 332 may configure a motion information candidate list based on neighboring blocks and derive a motion vector and/or a reference picture index of the current block based on received candidate selection information. Inter prediction may be performed based on various prediction modes, and the information on prediction may include information indicating an inter prediction mode for the current block.

An adder 340 may add an obtained residual signal to a prediction signal (a prediction block, a prediction sample array) output from a predictor (including an inter predictor 332 and/or an intra predictor 331) to generate a reconstructed signal (a reconstructed picture, a reconstructed block, a reconstructed sample array). When there is no residual for a block to be processed like when a skip mode is applied, a prediction block may be used as a reconstructed block.

An adder 340 may be referred to as a reconstructor or a reconstructed block generator. A generated reconstructed signal may be used for intra prediction of a next block to be processed in a current picture, may be output through filtering as described later or may be used for inter prediction of a next picture. Meanwhile, luma mapping with chroma scaling (LMCS) may be applied in a picture decoding process.

A filter 350 may improve subjective/objective image quality by applying filtering to a reconstructed signal. For example, a filter 350 may generate a modified reconstructed picture by applying various filtering methods to a reconstructed picture and transmit the modified reconstructed picture to a memory 360, specifically a DPB of a memory 360. The various filtering methods may include deblocking filtering, sample adaptive offset, adaptive loop filter, bilateral filter, etc.

The (modified) reconstructed picture stored in the DPB of the memory 360 can be used as a reference picture in the inter prediction unit 332. A memory 360 may store motion information of a block from which motion information in a current picture is derived (or decoded) and/or motion information of blocks in a pre-reconstructed picture. The stored motion information may be transmitted to an inter predictor 260 to be used as motion information of a spatial neighboring block or motion information of a temporal neighboring block. A memory 360 may store reconstructed samples of reconstructed blocks in a current picture and transmit them to an intra predictor 331.

Herein, embodiments described in a filter 260, an inter predictor 221 and an intra predictor 222 of an encoding device 200 may be also applied equally or correspondingly to a filter 350, an inter predictor 332 and an intra predictor 331 of a decoding device 300, respectively.

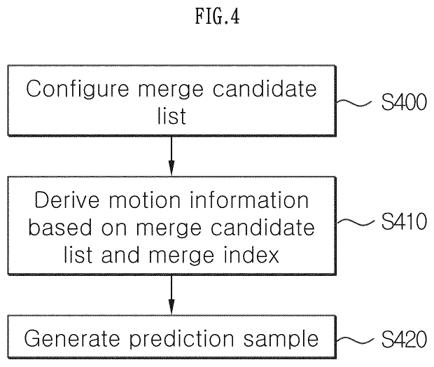

FIG. 4 shows an inter prediction method based on a merge mode performed by a decoding device as an embodiment to which the present disclosure is applied.

The motion information (a motion vector, a reference picture list, a reference picture index, etc.) of a current coding unit may be derived from motion information of a neighboring block without being encoded. The motion information of any one of neighboring blocks may be configured as motion information of a current coding unit, which is defined as a merge mode. In describing an embodiment of the present disclosure, a case in which a merge mode is used as an inter prediction mode is mainly described, but the present disclosure is not limited thereto. In other words, an embodiment described in the present disclosure may be substantially applied equally to other inter prediction modes (e.g., a skip mode, an AMVP mode, a combined inter intra prediction (CIIP) mode, an intra block copy mode, an affine mode, etc.).

Referring to FIG. 4, a decoding device may configure a merge candidate list of a current block S400.

A merge candidate list may include one or a plurality of merge candidates that may be used to derive motion information of a current block. A size of a merge candidate list may be variably determined based on information indicating the maximum number of merge candidates configuring a merge candidate list (hereinafter, size information). The size information may be encoded and signaled in an encoding device, or may be a fixed value that is pre-promised in a decoding device (e.g., an integer of 2, 3, 4, 5, 6 or more). In the present disclosure, a merge candidate list may be referred to as a merge list, a candidate list, etc.

A plurality of merge candidates included in a merge candidate list may include at least one of a spatial merge candidate or a temporal merge candidate.

A spatial merge candidate may refer to a neighboring block spatially adjacent to a current block or motion information of the neighboring block. Here, a neighboring block may include at least one of a bottom-left block (A0), a left block (A1), a top-right block (B0), a top block (B1) or a top-left block (B2) of a current block. According to a predetermined priority, an available neighboring block among the neighboring blocks may be sequentially added to a merge candidate list. For example, a priority may be defined as B1->A1->B0->A1->B2, A1->B1->A0->B1->B2, A1->B1->B0->A0->B2, etc., but it is not limited thereto.

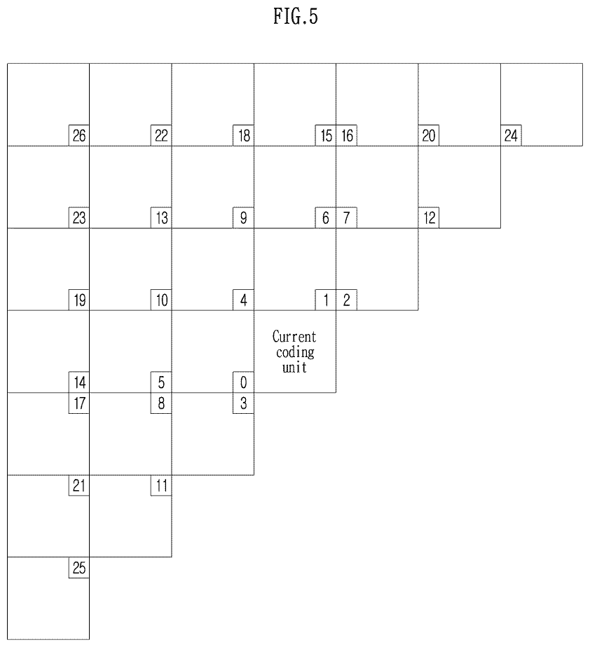

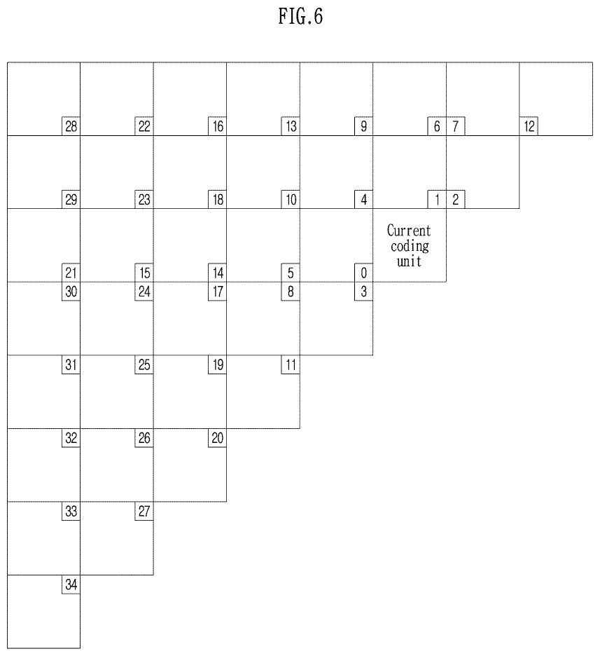

Meanwhile, a spatial merge candidate may further include a neighboring block that is not adjacent to a current block, which is described by referring to FIGS. 5 and 6.

A temporal merge candidate may refer to one or more co-located blocks belonging to a co-located picture or motion information of the co-located block. Here, a co-located picture is any one of a plurality of reference pictures belonging to a reference picture list, which may be a different picture from a picture to which a current block belongs. A co-located picture may be a first picture or a last picture in a reference picture list. Alternatively, a co-located picture may be specified based on an index encoded to indicate a co-located picture. A co-located block may include at least one of a block (C1) including a center position of a current block or a neighboring block (C0) adjacent to a bottom-right corner of a current block. According to a predetermined priority, an available block between C0 and C1 above may be sequentially added to a merge candidate list. For example, C0 may have a higher priority than C1. However, it is not limited thereto, and C1 may have a higher priority than C0.

An encoding/decoding device may include a buffer that stores motion information of at least one block for which encoding/decoding was completed before a current block (hereinafter, a previous block). In other words, a buffer may store a list consisting of motion information of a previous block (hereinafter, a motion information list).

The motion information list may be initialized in a unit of any one of a picture, a slice, a tile, a CTU row or a CTU. Initialization may mean that a motion information list is empty. The motion information of a corresponding previous block is sequentially added to a motion information list according to the encoding/decoding order of a previous block, but a motion information list may be updated in a first-in first-out (FIFO) manner by considering a size of a motion information list. For example, if the most recently encoded/decoded motion information (hereinafter, recent motion information) is the same as motion information that is pre-added to a motion information list, recent motion information may not be added to a motion information list. Alternatively, the same motion information as recent motion information may be removed from motion information list, and recent motion information may be added to a motion information list. In this case, recent motion information may be added to a last position of a motion information list or may be added to a position of removed motion information.

A previous block may include at least one of one or more neighboring blocks that are spatially adjacent to a current block or one or more neighboring blocks that are not spatially adjacent to a current block.

A merge candidate list may further include a previous block or motion information of a previous block belonging to a buffer or a motion information list as a merge candidate.

To this end, a redundancy check between a motion information list and a merge candidate list may be performed. A redundancy check may be performed on all or some of merge candidates belonging to a merge candidate list and all or part of previous blocks in a motion information list. However, for convenience of a description, it is assumed that a redundancy check in the present disclosure is performed on some of merge candidates belonging to a merge candidate list and some of previous blocks in a motion information list. Here, some merge candidates in a merge candidate list may include at least one of a left block or a top block among spatial merge candidates. However, it is not limited thereto, and may be limited to any one block among spatial merge candidates. For example, the some merge candidates may further include at least one of a bottom-left block, a top-right block, a top-left block or a temporal merge candidate. Some previous blocks in a motion information list may refer to K previous blocks recently added to a motion information list. Here, K is 1, 2, 3 or more, and may be a fixed value that is pre-promised in an encoding/decoding device.

For example, it is assumed that five previous blocks (or motion information of a previous block) are stored in a motion information list, and that index 1 to 5 is allocated to each previous block. As an index is larger, it refers to the recently stored previous block. In this case, redundancy of motion information between a previous block with index 5, 4 and 3 and some merge candidates in a merge candidate list may be checked. Alternatively, redundancy between a previous block with index 5 and 4 and some merge candidates in a merge candidate list may be checked. Alternatively, it is possible to exclude the most recently added previous block with index 5 and check redundancy between a previous block with index 4 and 3 and some merge candidates in a merge candidate list.

As a result of a redundancy check, if there is at least one previous block with different motion information, a corresponding previous block may be added to a merge candidate list. Alternatively, if there is at least one previous block with the same motion information, a previous block in a motion information list may not be added to a merge candidate list. On the other hand, if there is no previous block with the same motion information, all or part of previous blocks in a motion information list may be added to a last position of a merge candidate list. In this case, it may be added to a merge candidate list in the order of previous blocks recently added to a motion information list (i.e., from a large index to a small index). However, there may be a limit that a previous block most recently added to a motion information list (i.e., a previous block with the largest index) is not added to a merge candidate list. The previous block may be added by considering a size of a merge candidate list. For example, according to the size information of a merge candidate list described above, it is assumed that a merge candidate list has a maximum of T merge candidates. In this case, there may be a limit that a previous block is added only until the number of merge candidates belonging to a merge candidate list reaches (T-n). Here, n may be an integer of 1, 2 or more. Alternatively, a previous block may be added repeatedly until the number of merge candidates belonging to a merge candidate list reaches T.

As an embodiment, as described above, the plurality of merge candidates may include at least one of a spatial merge candidate having a motion vector of a block spatially adjacent to a current block, a temporal merge candidate having a motion vector of a block temporally adjacent to a current block, a non-adjacent spatial merge candidate having a motion vector of a block that is not spatially adjacent to a current block or a candidate derived by using an affine motion model of an affine block. In other words, a merge candidate list may include motion information of a block at a specific position that does not use an affine motion model, or may include motion information derived by using an affine motion model.

A decoding device may derive motion information of a current block based on a merge candidate list and a merge index S410.

A merge index may specify any one of a plurality of merge candidates belonging to a merge candidate list. Motion information of a current block may be configured as motion information of a merge candidate specified by a merge index. A decoding device may generate a prediction sample of a current block based on derived motion information S420. A decoding device may generate a prediction sample by performing motion compensation based on derived motion information. In other words, a decoding device may perform inter prediction for a current block based on derived motion information.

As an embodiment, pre-derived motion information (in particular, a motion vectors) may be corrected based on a predetermined difference motion vector (MVD). Motion compensation may be performed by using a corrected motion vector.

FIGS. 5 and 6 show a neighboring block that may be used as a spatial merge candidate as an embodiment to which the present disclosure is applied.

A neighboring block used in a merge mode may be a block adjacent to a current coding unit such as merge candidate index 0 to 4 in FIG. 5 (a block bordering a boundary of a current coding unit), or may be a block not adjacent to a current coding unit such as merge candidate index 5 to 26 in FIG. 5. If a merge candidate's distance from a current block exceeds a predefined threshold value, it may be configured to be unavailable.

For example, a pre-defined threshold value may be configured as a height of a CTU (ctu_height) or (ctu_height+N), which is defined as a merge candidate available threshold value. In other words, if a difference (i.e., yi−y0) between a y-axis coordinate (yi) of a merge candidate and a y-axis coordinate (y0) of a top-left sample of a current coding unit (hereinafter, a reference sample of a current coding unit) is greater than a merge candidate available threshold value, a merge candidate may be configured to be unavailable. Here, N is a predefined offset value. Specifically, for example, N may be configured as 16 or ctu_height.

If many merge candidates cross a CTU boundary, many unavailable merge candidates are generated, which may reduce encoding efficiency. A merge candidate at a top position of a coding unit (hereinafter, top merge candidate) may be configured as small as possible, and a merge candidate at a left and bottom position of a coding unit (hereinafter, a bottom-left merge candidate) may be configured as large as possible.

As in FIG. 6, a difference between a y-axis coordinate of a current coding unit reference sample and a y-axis coordinate of a top merge candidate may be configured not to exceed twice a height of a coding unit. A difference between a x-axis coordinate of a current coding unit reference sample and a x-axis coordinate of a bottom-left merge candidate may be configured not to exceed twice a width of a coding unit.

A merge candidate adjacent to a current coding unit is called an adjacent merge candidate, and a merge candidate that is not adjacent to a current coding unit is defined as a non-adjacent merge candidate. A flag (isAdjacentMergeflag) showing whether a merge candidate of a current coding unit is an adjacent merge candidate may be signaled. If a value of IsAdjacentMergeflag is 1, motion information of a current coding unit may be derived from an adjacent merge candidate, and if a value of isAdjacentMergeflag is 0, motion information of a current coding unit may be derived from a non-adjacent merge candidate.

According to a conventional image compression technology, when a non-affine merge mode is applied, motion information of a neighboring block at a predefined position is used as prediction information of a current block as it is. Here, a non-affine merge mode (or may be referred to as a non-affine mode) shows a mode that is not an affine merge mode (or an affine mode). In the present disclosure, a non-affine merge mode may be referred to as a merge mode, a general merge mode or a regular merge mode. When an affine mode is applied, a current block or a motion vector of a sub-block within a current block may be derived by using an affine motion model (or an affine model) derived based on a control point motion vector of a current block corner.

In other words, in a conventional non-affine prediction method, motion information that was already derived is used in a process of using motion information of a neighboring block as a prediction candidate. For example, when it is assumed that there is a block encoded as in FIG. 5, a predefined position, i.e., motion information of a neighboring block such as merge candidate index 0 to 4 in FIG. 5 is used as a prediction candidate of a non-affine merge for a current block.

In an embodiment of the present disclosure, in a process of configuring a prediction candidate for a non-affine merge mode, unlike a conventional image compression technology that uses motion information at a predefined position as prediction information of a current block as it is, if a surrounding block is encoded by using an affine motion model, a method for performing inter prediction by using motion information derived by using an affine motion model of a corresponding block is proposed.

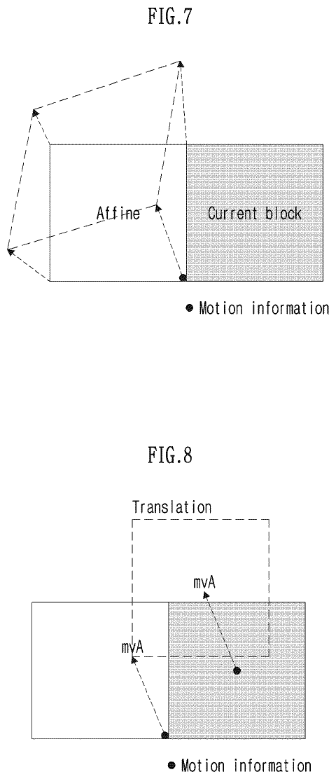

FIGS. 7 to 10 are a diagram for describing a non-affine merge mode using motion information of an affine block according to an embodiment of the present disclosure.

In an embodiment of the present disclosure, a method for deriving motion information from a surrounding affine block for a non-affine merge is proposed. In the present disclosure, an affine block represents a block encoded in an affine mode (or affine prediction), and may also be referred to as an affine coding block. This embodiment assumes that as shown in FIG. 7, a left block of a current block is an affine block. It is not limited thereto, and this embodiment may be equally applied even when a bottom-left, top, top-right or top-left neighboring block is an affine block.

Referring to FIG. 7, when a left block of a current block is encoded in an affine mode, motion information referred to as a prediction candidate may be motion information at a corresponding position derived as an affine motion model of a left block.

Referring to FIG. 8, when a left block of a current block is encoded in an affine mode, motion information at a left sample position referred to by a current block is referred to as mvA. According to a conventional image compression technology, as shown in FIG. 8, regardless of whether a left block of a current block is encoded in an affine mode, mvA, motion information of a reference sample derived as an affine motion model of a left block, may be used as a prediction candidate. In other words, according to a conventional image compression technology, when non-affine prediction is applied to a current block, motion information that is translated by motion information of a sample at a pre-defined position on the left may be used as a merge candidate.

In an embodiment of the present disclosure, when a neighboring block is encoded by affine prediction, motion information of a current block may be derived from an affine block of a corresponding affine block, and derived motion information may be used as a prediction candidate. In other words, as in FIGS. 7 and 8, when a left block of a current block is encoded in an affine mode, as shown in FIG. 9, motion information for a position of a current block may be derived by using an affine motion model of a left block.

By additionally considering motion information derived based on an affine motion model for prediction other than the existing motion information simply stored at predefined position, various movements may be considered as a candidate, increasing prediction accuracy and improving compression performance.

Specifically, as shown in FIG. 9, motion information of a current block may be derived based on an affine motion model of a left block. For an affine block, motion information (a motion vector) may be derived in a unit of a sub-block or in a unit of a pixel in a pre-determined size based on an affine motion model. In contrast, in the present disclosure, when a current block is a non-affine block, one motion information (motion vector) for a current block may be derived from an affine motion model of a neighboring affine block.

As an embodiment, motion information derived based on an affine motion model of a neighboring affine block may be used as a merge candidate. In other words, motion information derived based on an affine motion model of a neighboring affine block may be added (or inserted) into a merge candidate list as a merge candidate. A position of a neighboring affine block where an affine motion model is used may be defined as various positions. As an example, it may be a position defined above in FIGS. 5 and 6. As an example, a neighboring affine block may be a block adjacent to a current block. Alternatively, as an example, a neighboring affine block may be a block that is not adjacent to a current block.

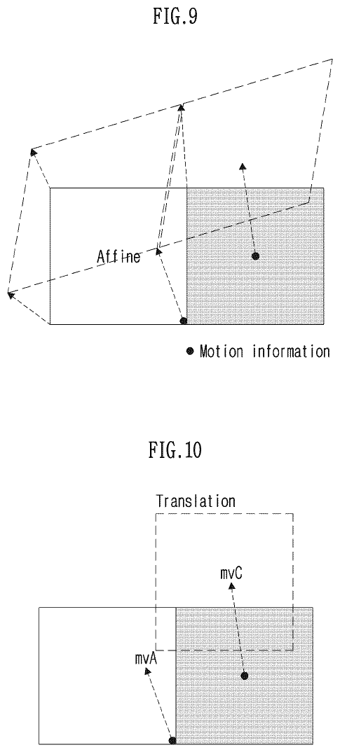

As an embodiment, an arbitrary position within a current block may be predefined to derive one motion information, and a motion vector for the predefined position may be derived from an affine motion model of a neighboring affine block. For example, the arbitrary position may be a top-left, right-bottom or top-right position of a current block. In an embodiment of FIG. 10, a center position of a current block is defined as the arbitrary position, and a case in which motion information of a corresponding position is derived from an affine motion model is described as an example.

As an embodiment, an affine motion model of a neighboring block may be determined based on a control point motion vector of a corresponding neighboring block and a width/a height of the neighboring block. The number of control points of a neighboring block may be 2, 3, or 4. A motion vector at a pre-defined position within a current block may be derived according to an affine motion model of the neighboring affine block based on a relative position of a current block for a neighboring affine block or a width/a height of the current block.

Referring to FIG. 10, unlike an embodiment described above in FIG. 8, new motion information mvC, not motion vector mvA at a left position, may be used as a prediction candidate. The new candidate may be derived from an affine motion model of a left affine block.

Referring to FIGS. 7 to 10, a method for using motion information (a motion vector) derived by using an affine motion model of a neighboring affine block as a merge candidate for a non-affine merge mode was described. Below, various methods for defining a position of a neighboring affine block for which an affine motion model is used are described.

FIG. 11 is a diagram illustrating a position of a neighboring block for candidate configuration according to an embodiment of the present disclosure.

In an embodiment of the present disclosure, a neighboring position (or a neighboring pixel position) referred to for configuring a candidate derived from a neighboring affine block in a non-affine merge mode as a merge candidate may be defined. As an embodiment, motion information may be derived from an affine motion model of a block including a corresponding position, and derived motion information may be added to a merge candidate list as a merge candidate. In other words, a position of a neighboring pixel referred to in a process of configuring an affine candidate of a neighboring block for a non-affine merge may be defined as in an example shown in FIG. 11.

Specifically, a position of a neighboring affine block used as a merge candidate in a non-affine merge mode may be defined as a position adjacent to a current block. For example, in an example of FIG. 11, it may be a left, bottom-left, top, top-right or top-left position adjacent to a current block.

Alternatively, a position of a neighboring affine block used as a merge candidate in a non-affine merge mode may be a position that is not adjacent to a current block. For example, the non-adjacent position may be the same as shown in FIG. 11. For example, the non-adjacent position may be defined as a position of a pixel included in a non-adjacent block positioned in a diagonal position to the top-left, the top-right or the bottom-left.

In addition, for example, the non-adjacent position may be defined as a position of a pixel included in a non-adjacent block positioned in a left or top direction. A non-adjacent block positioned in a left or top direction may be adaptively determined according to a width and/or a height of a current block. For example, a non-adjacent block positioned in a left or top direction may be specified as in an example of FIG. 11 based on a width and/or a height of a current block.

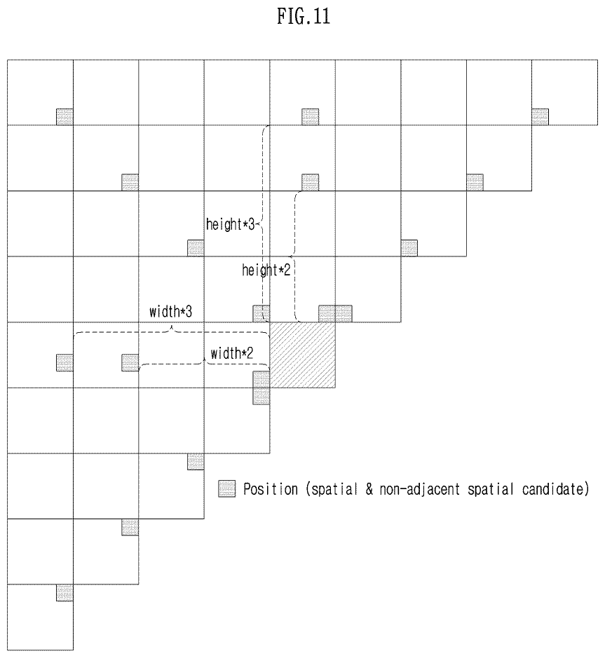

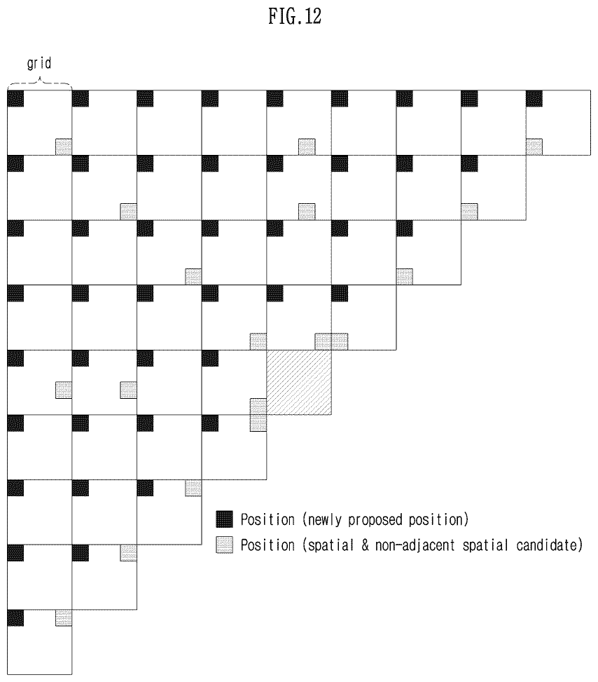

FIG. 12 is a diagram illustrating a position of a neighboring block for candidate configuration according to an embodiment of the present disclosure.

In an embodiment of the present disclosure, a neighboring position (or a neighboring pixel position) referred to for configuring a candidate derived from a neighboring affine block in a non-affine merge mode as a merge candidate may be defined. As an embodiment, motion information may be derived from an affine motion model of a block including a corresponding position, and derived motion information may be added to a merge candidate list as a merge candidate. In other words, a position of a neighboring pixel referred to in a process of configuring an affine candidate of a neighboring block for a non-affine merge may be defined as in an example shown in FIG. 12.

Referring to FIG. 12, a position of a neighboring affine block used as a merge candidate in a non-affine merge mode may be determined based on a grid. In the present disclosure, the grid represents a predetermined processing unit block, and is not limited by a name. The grid may be referred to as a block, a unit region, a sub-block, etc.

Specifically, a position of a neighboring affine block used as a merge candidate in a non-affine merge mode may be defined as a position of a pixel positioned in each grid. A size of the grid may be pre-configured. For example, the grid may be pre-configured as 4, 8, 16, 32, or 64.

As an example, as shown in FIG. 12, a position of a neighboring affine block used as a merge candidate in an affine merge mode may be a position of a top-left pixel within a grid having a pre-configured size.

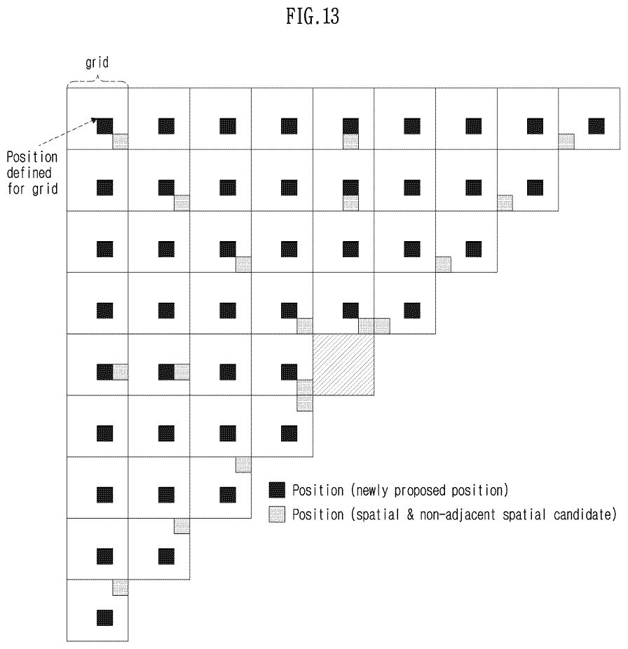

FIG. 13 is a diagram illustrating a position of a neighboring block for candidate configuration according to an embodiment of the present disclosure.

In an embodiment of the present disclosure, a neighboring position (or a neighboring pixel position) referred to for configuring a candidate derived from a neighboring affine block in a non-affine merge mode as a merge candidate may be defined. As an embodiment, motion information may be derived from an affine motion model of a block including a corresponding position, and derived motion information may be added to a merge candidate list as a merge candidate. In other words, a position of a neighboring pixel referred to in a process of configuring an affine candidate of a neighboring block for a non-affine merge may be defined as in an example shown in FIG. 13.

Referring to FIG. 13, a position of a neighboring affine block used as a merge candidate in a non-affine merge mode may be determined based on a grid. Specifically, a position of a neighboring affine block used as a merge candidate in a non-affine merge mode may be defined as a position of a pixel positioned in each grid. A size of the grid may be pre-configured. For example, the grid may be pre-configured as 4, 8, 16, 32, or 64.

As an embodiment, as shown in FIG. 13, a position of a neighboring affine block used as a merge candidate in an affine merge mode may be defined as a specific pixel position within a grid having a pre-configured size. For example, a position of a neighboring affine block used as a merge candidate in an affine merge mode may be a center pixel position within a grid having a pre-configured size. As another example, it may be defined as a top-right, bottom-left or a bottom-right pixel position.

FIG. 14 is a flowchart illustrating a method for configuring a merge candidate list according to an embodiment of the present disclosure.

Referring to FIG. 14, a method for configuring a merge candidate list to which an embodiment of the present disclosure may be applied is described. A method for configuring a merge candidate list in FIG. 14 is an example, and the present disclosure is not limited thereto. For example, the order of steps shown in FIG. 14 may be changed, some steps may be omitted, and steps other than those shown in FIG. 14 may be added.

In addition, an embodiment described above in FIG. 4 may be applied in the same manner, and in describing an embodiment in FIG. 14, a description that overlaps with FIG. 4 described above is omitted. In addition, in describing an embodiment in FIG. 14, for convenience of a description, it is described by assuming that it is performed by a decoding device, but it is not limited thereto, and may be also applied equally to an encoding device.

Referring to FIG. 14, a decoding device may add a spatial merge candidate to a merge candidate list S1400. A spatial merge candidate may refer to a neighboring block spatially adjacent to a current block or motion information of the neighboring block. Here, a neighboring block may include at least one of a bottom-left block (A0), a left block (A1), a top-right block (B0), a top block (B1) or a top-left block (B2) of a current block. According to a predetermined priority, an available neighboring block among the neighboring blocks may be sequentially added to a merge candidate list. In an embodiment, a top-left block (B2) may be added to a merge candidate list only when the remaining four neighboring blocks are not added to a merge candidate list as a merge candidate.

A decoding device may add a temporal merge candidate to a merge candidate list S1410. A temporal merge candidate may refer to one or more co-located blocks belonging to a co-located picture or motion information of the co-located block. Here, a co-located picture is any one of a plurality of reference pictures belonging to a reference picture list, which may be a different picture from a picture to which a current block belongs.

A co-located picture may be a first picture or a last picture in a reference picture list. Alternatively, a co-located picture may be specified based on an index encoded to indicate a co-located picture. A co-located block may include at least one of a block (C1) including a center position of a current block or a neighboring block (C0) adjacent to a bottom-right corner of a current block. According to a predetermined priority, an available block between C0 and C1 above may be sequentially added to a merge candidate list.

A decoding device may add a history-based motion ventor predictor (HMVP) to a merge candidate list S1420. A HMVP represents motion information of a block coded before a current block. A HMVP added to a merge candidate list may be derived from a HMVP candidate list. In the present disclosure, a HMVP candidate list may be referred to as a HMVP list, a HMVP buffer, a HMVP table, a lookup table, a HMVP lookup table, etc.

A decoding device may add an average merge candidate to a merge candidate list S1430. An average merge candidate may be derived by averaging motion information (a motion vector) of a merge candidate included in a merge candidate list. An average merge candidate may also be referred to as a pairwise candidate. As an example, a motion vector of an average merge candidate may be derived by averaging a motion vector of two candidates included in a merge candidate list. In addition, as an example, the two candidates may be defined as a first candidate and a second candidate in a merge candidate list.

As an embodiment, an availability check and/or a redundancy check may be performed prior to adding a candidate in each step of FIG. 14 described above. In addition, before adding a HMVP, whether the number of merge candidates included in a merge candidate list is a value obtained by subtracting 1 from the maximum number of merge candidate lists may be confirmed. In addition, before adding an average merge candidate, whether the number of merge candidates included in a merge candidate list is less than a value obtained by subtracting 1 from the maximum number of merge candidate lists may be confirmed.

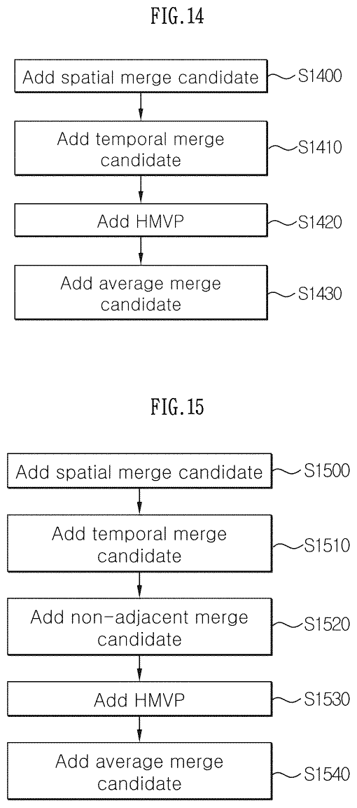

FIG. 15 is a flowchart illustrating a method for configuring a merge candidate list according to an embodiment of the present disclosure.

Referring to FIG. 15, a method for configuring a merge candidate list to which an embodiment of the present disclosure may be applied is described. A method for configuring a merge candidate list in FIG. 15 is an example, and the present disclosure is not limited thereto. For example, the order of steps shown in FIG. 15 may be changed, some steps may be omitted, and steps other than those shown in FIG. 15 may be added. In addition, an embodiment described above in FIG. 4 may be applied in the same manner, and in describing an embodiment in FIG. 15, a description that overlaps with FIG. 4 described above is omitted. In addition, in describing an embodiment in FIG. 15, for convenience of a description, it is described by assuming that it is performed by a decoding device, but it is not limited thereto, and may be also applied equally to an encoding device.

Referring to FIG. 15, a decoding device may add a spatial merge candidate to a merge candidate list S1500 and may add a temporal merge candidate to a merge candidate list S1510.

A decoding device may add motion information of a non-adjacent block as a merge candidate S1520. As described above in FIGS. 5, 6, 11 to 13, motion information of a non-adjacent block that is not adjacent to a current block may be added to a merge candidate list. A position of a non-adjacent block may be predefined. For example, it may be defined as a position described above in FIGS. 5, 6, 11 to 13. As an example, motion information of a non-adjacent block at K positions may be added to a merge candidate list. K may be a predefined value. For example, K may be an integer greater than 2. For example, K may be 18.

And, a decoding device may add a history-based motion ventor predictor (HMVP) to a merge candidate list S1530. A decoding device may add an average merge candidate to a merge candidate list S1540.

As an embodiment, an availability check and/or a redundancy check may be performed prior to adding a candidate in each step of FIG. 15 described above. In addition, before adding motion information of a non-adjacent block as a merge candidate, whether the number of merge candidates included in a merge candidate list is smaller than the maximum number of merge candidate lists may be confirmed.

In addition, before adding a HMVP, whether the number of merge candidates included in a merge candidate list is a value obtained by subtracting 1 from the maximum number of merge candidate lists may be confirmed. In addition, before adding an average merge candidate, whether the number of merge candidates included in a merge candidate list is less than a value obtained by subtracting 1 from the maximum number of merge candidate lists may be confirmed.

Below, an embodiment in which a merge candidate list is configured by using motion information derived from an affine motion model of a neighboring affine block described above in FIGS. 7 to 13 is described.

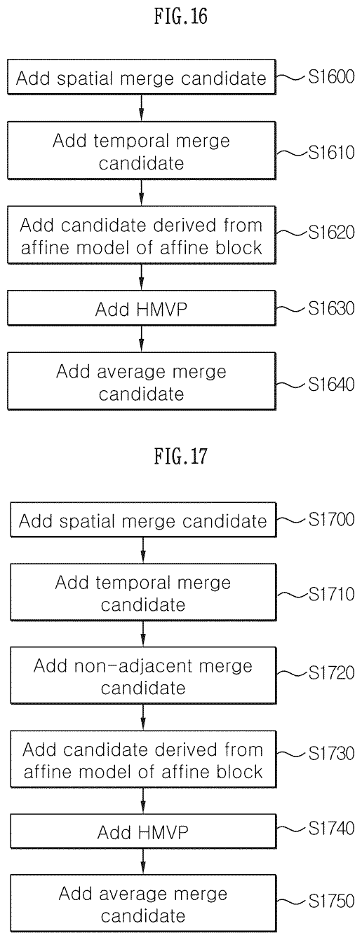

FIG. 16 is a flowchart illustrating a method for configuring a merge candidate list according to an embodiment of the present disclosure.

Referring to FIG. 16, a method for configuring a merge candidate list to which an embodiment of the present disclosure may be applied is described. A method for configuring a merge candidate list in FIG. 16 is an example, and the present disclosure is not limited thereto. For example, the order of steps shown in FIG. 16 may be changed, some steps may be omitted, and steps other than those shown in FIG. 16 may be added.

In addition, an embodiment described above in FIGS. 4 and 14 may be equally applied, and in describing an embodiment in FIG. 16, a description that overlaps with FIGS. 4 and 14 described above is omitted. In addition, in describing an embodiment in FIG. 16, for convenience of a description, it is described by assuming that it is performed by a decoding device, but it is not limited thereto, and may be also applied equally to an encoding device.

Referring to FIG. 16, a decoding device may add a spatial merge candidate to a merge candidate list S1600 and may add a temporal merge candidate to a merge candidate list S1610.

A decoding device may add motion information derived by using an affine motion model of a neighboring affine block as a merge candidate to a merge candidate list S1620. A method described above in FIGS. 7 to 13 may be applied. In this regard, an overlapping description is omitted.

A decoding device may derive motion information by using an affine motion model of an affine block among neighboring blocks spatially adjacent to a current block, and add derived motion information to a merge candidate list. A neighboring block spatially adjacent to the current block may include at least one of a bottom-left block (A0), a left block (A1), a top-right block (B0), a top block (B1) or a top-left block (B2) of a current block. According to a predetermined priority, a neighboring block that is both an affine block and available among the neighboring blocks may be sequentially added to a merge candidate list.

A decoding device may add a history-based motion ventor predictor (HMVP) to a merge candidate list S1630 and may add an average merge candidate to a merge candidate list S1640.

As an embodiment, an availability check and/or a redundancy check may be performed prior to adding a candidate in each step of FIG. 16 described above. In addition, before adding motion information derived based on an affine motion model of a neighboring block, whether a corresponding neighboring block was encoded by affine prediction may be confirmed.

In addition, before adding motion information derived based on an affine motion model of a neighboring block, whether the number of spatial merge candidates added to a merge candidate list is smaller than M and/or whether the number of merge candidates included in a merge candidate list is less than a value obtained by subtracting N from the maximum number of merge candidate lists may be confirmed. Here, M and N represent a predefined value. As an example, the M may be defined as one of 4, 5, 6, or 7.

In addition, before adding a HMVP, whether the number of merge candidates included in a merge candidate list is a value obtained by subtracting 1 from the maximum number of merge candidate lists may be confirmed. In addition, before adding an average merge candidate, whether the number of merge candidates included in a merge candidate list is less than a value obtained by subtracting 1 from the maximum number of merge candidate lists may be confirmed.

FIG. 17 is a flowchart illustrating a method for configuring a merge candidate list according to an embodiment of the present disclosure.

Referring to FIG. 17, a method for configuring a merge candidate list to which an embodiment of the present disclosure may be applied is described. A method for configuring a merge candidate list in FIG. 17 is an example, and the present disclosure is not limited thereto. For example, the order of steps shown in FIG. 17 may be changed, some steps may be omitted, and steps other than those shown in FIG. 17 may be added.

In addition, an embodiment described above in FIGS. 4 and 15 may be equally applied, and in describing an embodiment in FIG. 17, a description that overlaps with FIGS. 4 and 15 described above is omitted. In addition, in describing an embodiment in FIG. 17, for convenience of a description, it is described by assuming that it is performed by a decoding device, but it is not limited thereto, and may be also applied equally to an encoding device.

Referring to FIG. 17, a decoding device may add a spatial merge candidate to a merge candidate list S1700 and may add a temporal merge candidate to a merge candidate list S1710. And, a decoding device may add motion information of a non-adjacent block as a merge candidate S1720.

A decoding device may add motion information derived by using an affine motion model of an affine block to a merge candidate list S1730. A method described above in FIGS. 7 to 13 may be applied. In this regard, an overlapping description is omitted.

A decoding device may derive motion information by using an affine motion model of an affine block, and add derived motion information to a merge candidate list. Here, an affine block may include a neighboring block spatially adjacent to a current block and a block at a specific position that is not adjacent to a current block. A neighboring block spatially adjacent to the current block may include at least one of a bottom-left block (A0), a left block (A1), a top-right block (B0), a top block (B1) or a top-left block (B2) of a current block. According to a predetermined priority, a neighboring block that is both an affine block and available among the neighboring blocks may be sequentially added to a merge candidate list.

In addition, a non-adjacent block may be defined as described above in FIGS. 5, 6, 11 to 13. As an example, a block that whether it is a block encoded in an affine mode is confirmed may be 5 adjacent blocks and 18 non-adjacent blocks.

And, a decoding device may add a HMVP (i.e., a history-based motion ventor predictor) to a merge candidate list S1740. A decoding device may add an average merge candidate to a merge candidate list S1750.

As an embodiment, an availability check and/or a redundancy check may be performed prior to adding a candidate in each step of FIG. 17 described above. In addition, before adding motion information of a non-adjacent block as a merge candidate, whether the number of merge candidates included in a merge candidate list is smaller than the maximum number of merge candidate lists may be confirmed.

In addition, before adding motion information derived based on an affine motion model of a neighboring block, whether a corresponding neighboring block was encoded by affine prediction may be confirmed.

In addition, before adding motion information derived based on an affine motion model of a neighboring block, whether the number of spatial merge candidates added to a merge candidate list is smaller than M and/or whether the number of merge candidates included in a merge candidate list is less than a value obtained by subtracting N from the maximum number of merge candidate lists may be confirmed. Here, M and N represent a predefined value. As an example, the M may be defined as 23.

In addition, before adding a HMVP, whether the number of merge candidates included in a merge candidate list is a value obtained by subtracting 1 from the maximum number of merge candidate lists may be confirmed. In addition, before adding an average merge candidate, whether the number of merge candidates included in a merge candidate list is less than a value obtained by subtracting 1 from the maximum number of merge candidate lists may be confirmed.

FIGS. 16 and 17 above described a case in which a candidate derived by using an affine motion model of a neighboring affine block is inserted into a merge candidate list as a separate candidate distinct from a spatial merge candidate or a non-adjacent spatial merge candidate.

In another embodiment of the present disclosure, a candidate derived by using an affine motion model of neighboring affine block may be inserted into a merge candidate list as a spatial merge candidate or a non-adjacent spatial merge candidate.

In other words, as an example, in configuring a spatial merge candidate, a decoding device may confirm whether a neighboring block of a current block is a block encoded in an affine mode. If a neighboring block of a current block is an affine block, a decoding device may add motion information derived by using an affine motion model of a corresponding affine block to a merge candidate list as a spatial merge candidate. A related operation may be performed in S1400 of FIGS. 14 and S1500 of FIG. 15.

In addition, as an example, in configuring a non-adjacent spatial merge candidate, a decoding device may confirm whether a non-adjacent block is a block encoded in an affine mode. If a non-adjacent block is an affine block, a decoding device may add motion information derived by using an affine motion model of a corresponding affine block to a merge candidate list as a non-adjacent spatial merge candidate. A related operation may be performed in S1520 of FIG. 15.

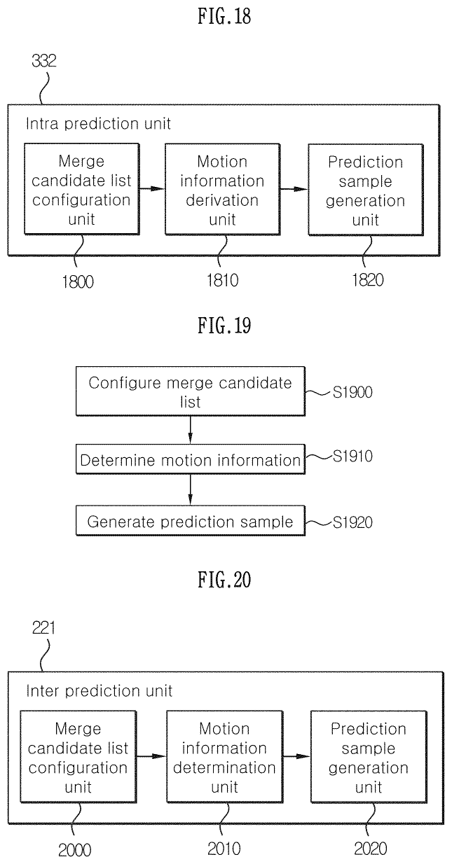

FIG. 18 shows a rough configuration of an inter prediction unit 332 that performs merge mode-based inter prediction as an embodiment according to the present disclosure.

An inter prediction method based on an affine model performed by a decoding device was described by referring to FIG. 4, which may be equally performed in an inter prediction unit 332 of a decoding device. Accordingly, an overlapping description is omitted here.

Referring to FIG. 18, an inter prediction unit 332 may include a merge candidate list configuration unit 1800, a motion information derivation unit 1810 and a prediction sample generation unit 1820.

A merge candidate list configuration unit 1800 may configure a merge candidate list of a current block.

A merge candidate list may include one or a plurality of merge candidates that may be used to derive motion information of a current block. A size of a merge candidate list may be variably determined based on information indicating the maximum number of merge candidates configuring a merge candidate list (hereinafter, size information). The size information may be encoded and signaled in an encoding device, or may be a fixed value that is pre-promised in a decoding device (e.g., an integer of 2, 3, 4, 5, 6 or more).

A plurality of merge candidates included in a merge candidate list may include at least one of a spatial merge candidate or a temporal merge candidate.

A spatial merge candidate and a temporal merge candidate are the same as described by referring to FIG. 4, and a detailed description is omitted here. Meanwhile, a spatial merge candidate may further include a neighboring block that is not adjacent to a current block. It is the same as described by referring to FIGS. 5 and 6, and a detailed description is omitted here.

A merge candidate list configuration unit 1800 may use motion information derived by using an affine motion model of a neighboring affine block as a merge candidate for a non-affine merge mode. It is the same as described by referring to FIG. 7 to FIG. 10, and a detailed description is omitted here.

In addition, a merge candidate list configuration unit 1800 may define a position of a neighboring affine block in which an affine motion model is used. It is the same as described by referring to FIG. 11 to FIG. 13, and a detailed description is omitted here.

In addition, a merge candidate list configuration unit 1800 may insert a candidate derived by using an affine motion model of a neighboring affine block into a merge candidate list as a separate candidate distinct from a spatial merge candidate or a non-adjacent spatial merge candidate. It is the same as described by referring to FIGS. 16 and 17, and a detailed description is omitted here.

In addition, a merge candidate list configuration unit 1800 may insert a candidate derived by using an affine motion model of a neighboring affine block into a merge candidate list as a spatial merge candidate or a non-adjacent spatial merge candidate. It is the same as described by referring to FIGS. 16 and 17, and a detailed description is omitted here.

A motion information derivation unit 1810 may derive motion information of a current block based on a merge candidate list and a merge index.

A merge index may specify any one of a plurality of merge candidates belonging to a merge candidate list. Motion information of a current block may be configured as motion information of a merge candidate specified by a merge index.

A prediction sample generation unit 1820 may generate a prediction sample of a current block based on derived motion information. A prediction sample generation unit 1820 may generate a prediction sample by performing motion compensation (i.e., inter prediction) based on derived motion information.

FIG. 19 shows an inter prediction method based on a merge mode performed by an encoding device as an embodiment according to the present disclosure.

Hereinafter, an inter prediction method based on an affine model performed in a decoding device was described by referring to FIG. 4, which may be applied equally/similarly to an inter prediction method based on an affine model performed in an encoding device. Accordingly, an overlapping description is omitted here.

An encoding device may configure a merge candidate list of a current block S1900.

A merge candidate list may include one or a plurality of merge candidates that may be used to derive motion information of a current block. A size of a merge candidate list may be variably determined based on information indicating the maximum number of merge candidates configuring a merge candidate list (hereinafter, size information). The size information may be encoded and signaled in an encoding device, or may be a fixed value that is pre-promised in a decoding device (e.g., an integer of 2, 3, 4, 5, 6 or more).

A plurality of merge candidates included in a merge candidate list may include at least one of a spatial merge candidate or a temporal merge candidate.

A spatial merge candidate and a temporal merge candidate are the same as described by referring to FIG. 4, and a detailed description is omitted here. Meanwhile, a spatial merge candidate may further include a neighboring block that is not adjacent to a current block. It is the same as described by referring to FIGS. 5 and 6, and a detailed description is omitted here.

An encoding device may use motion information derived by using an affine motion model of a neighboring affine block as a merge candidate for a non-affine merge mode. It is the same as described by referring to FIG. 7 to FIG. 10, and a detailed description is omitted here.

In addition, an encoding device may define a position of a neighboring affine block in which an affine motion model is used. It is the same as described by referring to FIG. 11 to FIG. 13, and a detailed description is omitted here.

In addition, an encoding device may insert a candidate derived by using an affine motion model of a neighboring affine block into a merge candidate list as a separate candidate distinct from a spatial merge candidate or a non-adjacent spatial merge candidate. It is the same as described by referring to FIGS. 16 and 17, and a detailed description is omitted here.

In addition, an encoding device may insert a candidate derived by using an affine motion model of a neighboring affine block into a merge candidate list as a spatial merge candidate or a non-adjacent spatial merge candidate. It is the same as described by referring to FIGS. 16 and 17, and a detailed description is omitted here.

An encoding device may determine motion information of a current block based on a merge candidate list S1910. An encoding device may signal a merge index specifying a candidate used for inter prediction of a current block among a plurality of candidates included in a merge candidate list to a decoding device

A merge index may specify any one of a plurality of merge candidates belonging to a merge candidate list. Motion information of a current block may be configured as motion information of a merge candidate specified by a merge index.

An encoding device may generate a prediction sample of a current block based on determined motion information S1920. An encoding device may generate a prediction sample by performing motion compensation (i.e., inter prediction) based on determined motion information.

FIG. 20 shows a rough configuration of an inter prediction unit 221 that performs merge mode-based inter prediction as an embodiment according to the present disclosure.

An inter prediction method based on an affine model performed in an encoding device was described by referring to FIG. 19, which may be performed equally in an inter prediction unit 221 of an encoding device. Accordingly, an overlapping description is omitted here.

Referring to FIG. 20, an inter prediction unit 221 may include a merge candidate list configuration unit 2000, a motion information determination unit 2010 and a prediction sample generation unit 2020.

A merge candidate list configuration unit 2000 may configure a merge candidate list of a current block.

A merge candidate list may include one or a plurality of merge candidates that may be used to derive motion information of a current block. A size of a merge candidate list may be variably determined based on information indicating the maximum number of merge candidates configuring a merge candidate list (hereinafter, size information). The size information may be encoded and signaled in an encoding device, or may be a fixed value that is pre-promised in a decoding device (e.g., an integer of 2, 3, 4, 5, 6 or more).

A plurality of merge candidates included in a merge candidate list may include at least one of a spatial merge candidate or a temporal merge candidate.

A spatial merge candidate and a temporal merge candidate are the same as described by referring to FIG. 4, and a detailed description is omitted here. Meanwhile, a spatial merge candidate may further include a neighboring block that is not adjacent to a current block. It is the same as described by referring to FIGS. 5 and 6, and a detailed description is omitted here.

A merge candidate list configuration unit 2000 may use motion information derived by using an affine motion model of a neighboring affine block as a merge candidate for a non-affine merge mode. It is the same as described by referring to FIG. 7 to FIG. 10, and a detailed description is omitted here.

In addition, a merge candidate list configuration unit 2000 may define a position of a neighboring affine block in which an affine motion model is used. It is the same as described by referring to FIG. 11 to FIG. 13, and a detailed description is omitted here.

In addition, a merge candidate list configuration unit 2000 may insert a candidate derived by using an affine motion model of a neighboring affine block into a merge candidate list as a separate candidate distinct from a spatial merge candidate or a non-adjacent spatial merge candidate. It is the same as described by referring to FIGS. 16 and 17, and a detailed description is omitted here.

In addition, a merge candidate list configuration unit 2000 may insert a candidate derived by using an affine motion model of a neighboring affine block into a merge candidate list as a spatial merge candidate or a non-adjacent spatial merge candidate. It is the same as described by referring to FIGS. 16 and 17, and a detailed description is omitted here.

A motion information determination unit 2010 may determine motion information of a current block based on a merge candidate list. An encoding device may signal a merge index specifying a candidate used for inter prediction of a current block among a plurality of candidates included in a merge candidate list to a decoding device.

A merge index may specify any one of a plurality of merge candidates belonging to a merge candidate list. Motion information of a current block may be configured as motion information of a merge candidate specified by a merge index.

A prediction sample generation unit 2020 may generate a prediction sample of a current block based on determined motion information. An encoding device may generate a prediction sample by performing motion compensation (i.e., inter prediction) based on determined motion information.

In the above-described embodiment, methods are described based on a flowchart as a series of steps or blocks, but a corresponding embodiment is not limited to the order of steps, and some steps may occur simultaneously or in different order with other steps as described above. In addition, those skilled in the art may understand that steps shown in a flowchart are not exclusive, and that other steps may be included or one or more steps in a flowchart may be deleted without affecting the scope of embodiments of the present disclosure.

The above-described method according to embodiments of the present disclosure may be implemented in a form of software, and an encoding device and/or a decoding device according to the present disclosure may be included in a device which performs image processing such as a TV, a computer, a smartphone, a set top box, a display device, etc.

In the present disclosure, when embodiments are implemented as software, the above-described method may be implemented as a module (a process, a function, etc.) that performs the above-described function. A module may be stored in a memory and may be executed by a processor. A memory may be internal or external to a processor, and may be connected to a processor by a variety of well-known means. A processor may include an application-specific integrated circuit (ASIC), another chipset, a logic circuit and/or a data processing device. A memory may include a read-only memory (ROM), a random access memory (RAM), a flash memory, a memory card, a storage medium and/or another storage device. In other words, embodiments described herein may be performed by being implemented on a processor, a microprocessor, a controller or a chip. For example, functional units shown in each drawing may be performed by being implemented on a computer, a processor, a microprocessor, a controller or a chip. In this case, information for implementation (ex. information on instructions) or an algorithm may be stored in a digital storage medium.

In addition, a decoding device and an encoding device to which embodiment(s) of the present disclosure are applied may be included in a multimedia broadcasting transmission and reception device, a mobile communication terminal, a home cinema video device, a digital cinema video device, a surveillance camera, a video conversation device, a real-time communication device like a video communication, a mobile streaming device, a storage medium, a camcorder, a device for providing video on demand (VoD) service, an over the top video (OTT) device, a device for providing Internet streaming service, a three-dimensional (3D) video device, a virtual reality (VR) device, an argumente reality (AR) device, a video phone video device, a transportation terminal (ex. a vehicle (including an autonomous vehicle) terminal, an airplane terminal, a ship terminal, etc.) and a medical video device, etc., and may be used to process a video signal or a data signal. For example, an over the top video (OTT) device may include a game console, a blu-ray player, an Internet-connected TV, a home theater system, a smartphone, a tablet PC, a digital video recorder (DVR), etc.

In addition, a processing method to which embodiment(s) of the present disclosure are applied may be produced in a form of a program executed by a computer and may be stored in a computer-readable recording medium. Multimedia data having a data structure according to embodiment(s) of the present disclosure may be also stored in a computer-readable recording medium. The computer-readable recording medium includes all types of storage devices and distributed storage devices that store computer-readable data. The computer-readable recording medium may include, for example, a blu-ray disk (BD), an universal serial bus (USB), ROM, PROM, EPROM, EEPROM, RAM, CD-ROM, a magnetic tape, a floppy disk and an optical media storage device. In addition, the computer-readable recording medium includes media implemented in a form of a carrier wave (e.g., transmission via the Internet). In addition, a bitstream generated by an encoding method may be stored in a computer-readable recording medium or may be transmitted through a wired or wireless communication network.

In addition, embodiment(s) of the present disclosure may be implemented by a computer program product by a program code, and the program code may be executed on a computer by embodiment(s) of the present disclosure. The program code may be stored on a computer-readable carrier.

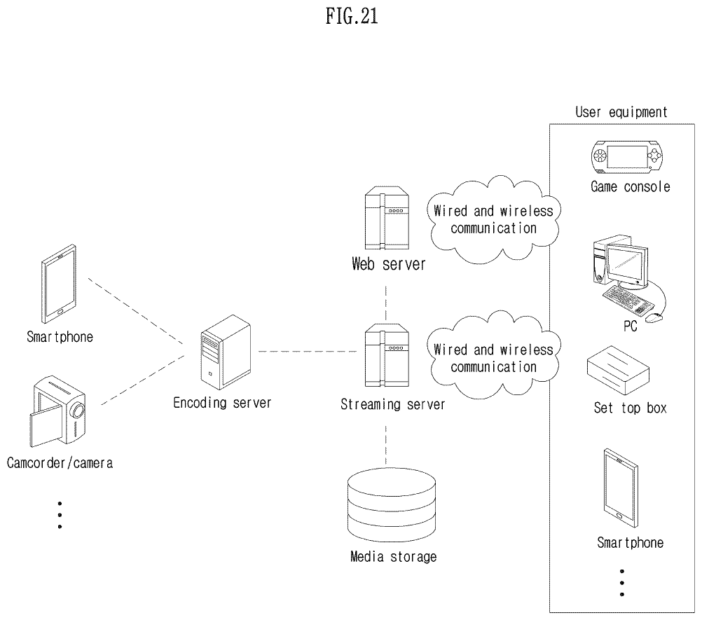

FIG. 21 shows an example of a contents streaming system to which embodiments of the present disclosure may be applied.

Referring to FIG. 21, a contents streaming system to which embodiment(s) of the present disclosure are applied may largely include an encoding server, a streaming server, a web server, a media storage, a user device and a multimedia input device.

The encoding server generates a bitstream by compressing contents input from multimedia input devices such as a smartphone, a camera, a camcorder, etc. into digital data and transmits it to the streaming server. As another example, when multimedia input devices such as a smartphone, a camera, a camcorder, etc. directly generate a bitstream, the encoding server may be omitted.

The bitstream may be generated by an encoding method or a bitstream generation method to which embodiment(s) of the present disclosure are applied, and the streaming server may temporarily store the bitstream in a process of transmitting or receiving the bitstream.

The streaming server transmits multimedia data to a user device based on a user's request through a web server, and the web server serves as a medium to inform a user of what service is available. When a user requests desired service from the web server, the web server delivers it to a streaming server, and the streaming server transmits multimedia data to a user. In this case, the contents streaming system may include a separate control server, and in this case, the control server controls a command/a response between each device in the content streaming system.

The streaming server may receive contents from a media storage and/or an encoding server. For example, when contents is received from the encoding server, the contents may be received in real time. In this case, in order to provide smooth streaming service, the streaming server may store the bitstream for a certain period of time.

An example of the user device may include a mobile phone, a smart phone, a laptop computer, a digital broadcasting terminal, a personal digital assistants (PDAs), a portable multimedia players (PMP), a navigation, a slate PC, a Tablet PC, an ultrabook, a wearable device (e.g., a smartwatch, a smart glass, a head mounted display (HMD), a digital TV, a desktop, a digital signage, etc.

Each server in the contents streaming system may be operated as a distributed server, and in this case, data received from each server may be distributed and processed.

The claims set forth herein may be combined in various ways. For example, a technical characteristic of a method claim of the present disclosure may be combined and implemented as a device, and a technical characteristic of a device claim of the present disclosure may be combined and implemented as a method.

In addition, a technical characteristic of a method claim of the present disclosure and a technical characteristic of a device claim may be combined and implemented as a device, and a technical characteristic of a method claim of the present disclosure and a technical characteristic of a device claim may be combined and implemented as a method.

1. An image decoding method, the method comprising:
configuring a merge candidate list of a current block, wherein the merge candidate list includes a candidate derived by using an affine motion model of an affine block coded by an affine prediction;
deriving motion information of the current block based on the merge candidate list and a merge index, wherein the merge index indicates one of a plurality of candidates included in the merge candidate list; and
performing an inter prediction for the current block based on the motion information of the current block.

2. The method of claim 1, wherein:
motion information of the candidate derived by using the affine motion model of the affine block is motion information derived for a predefined position in the current block from the affine motion model.

3. The method of claim 2, wherein:
the predefined position is defined as one of a top-left position, a bottom-left position, a top-right position, a bottom-right position or a center position of the current block.

4. The method of claim 1, wherein:
the affine block is determined as a block coded by the affine prediction among blocks at a predefined position based on the current block.

5. The method of claim 4, wherein:
whether it is a block coded by the affine prediction among the blocks at the predefined position is confirmed according to a predetermined priority.

6. The method of claim 1, wherein:
the affine block is determined as a block coded by the affine prediction among spatial merge candidates of the current block.

7. The method of claim 1, wherein:
the affine block is determined as a block coded by the affine prediction among non-adjacent spatial merge candidates that are not adjacent to the current block.

8. The method of claim 7, wherein:
a position of a non-adjacent spatial merge candidate that is not adjacent to the current block is adaptively determined based on a width and a height of the current block.

9. The method of claim 7, wherein:
a position of a non-adjacent spatial merge candidate that is not adjacent to the current block is defined as a specific position in a grid with a predefined size.

10. The method of claim 1, wherein:
the merge candidate list includes a plurality of merge candidates,
the plurality of merge candidates includes at least one of a spatial merge candidate having a motion vector of a block spatially adjacent to the current block, a temporal merge candidate having a motion vector of a block temporally adjacent to the current block, a non-adjacent spatial merge candidate having a motion vector of a block not spatially adjacent to the current block or a candidate derived by using an affine motion model of an affine block.

11. The method of claim 1, wherein:
performing the inter prediction is performed by generating a prediction block of the current block from one reference block specified by the motion information of the current block.

12. An image encoding method, the method comprising:
configuring a merge candidate list of a current block, wherein the merge candidate list includes a candidate derived by using an affine motion model of an affine block coded by an affine prediction,
determining motion information of the current block based on the merge candidate list; and
performing an inter prediction for the current block based on the motion information of the current block.

13. (canceled)

14. A method for transmitting data for image information, the method comprising:
generating a bitstream for the image information, wherein the bitstream is generated based on configuring a merge candidate list of a current block, wherein the merge candidate list includes a candidate derived by using an affine motion model of an affine block coded by an affine prediction,
determining motion information of the current block based on the merge candidate list, and
performing an inter prediction for the current block based on the motion information of the current block; and
transmitting the data including the bitstream.
